(19) United States
(12) Patent Application Publication
(10) Pub. No.: US 2026/0338534 A1
(43) Pub. Date: Oct. 29, 2026

(54) APPARATUS AND METHOD FOR DETERMINING THE ANGLE OF A ROTATING SHAFT

(71) Applicant: Infineon Technologies AG, Neubiberg (DE)

(72) Inventors: Gernot BINDER, Klagenfurt (AT); Sebastian MÄRZ, Neubiberg (DE)

(21) Appl. No.: 19/655,161

(22) Filed: Apr. 22, 2026

(30) Foreign Application Priority Data
Apr. 28, 2025 (DE) 102025116274.3
Mar. 18, 2026 (DE) 102026110975.6

(51) Int. Cl. G01B 7/30; G01D 5/14; G01D 5/16; G01D 18/00

(52) U.S. Cl. CPC G01B 7/30; G01D 5/145; G01D 5/16; G01D 18/00

(57) ABSTRACT

An apparatus includes a permanent magnet fastened to a rotating shaft and at least two magnetic sensor devices which are each arranged at a pole-pair-dependent angular offset and generate differential output signals. A further apparatus includes at least three magnetic field sensors arranged with equidistant angular spacing, and an evaluation unit which derives a sine signal and a cosine signal using a transformation and calculates angle information therefrom.

### CROSS-REFERENCE TO RELATED APPLICATION

This application claims priority to Germany Patent Application No. 102025116274.3, filed Apr. 28, 2025, and Germany Patent Application No. 102026110975.6, filed Mar. 18, 2026, the contents of which are incorporated herein by reference in their entireties.

### TECHNICAL FIELD

The present disclosure relates to apparatuses and methods for determining the angle of a rotating shaft, in particular angle measurement systems which are arranged outside of a shaft (OoS: out of shaft).

### BACKGROUND

Out-of-shaft angle measurement systems can be used to measure an angular position of a rotating shaft, especially when the ends of the shaft are not accessible. The prior art comprises magnetic resolvers and inductive sensors which can be used, for example, in the automotive industry. In magnetic resolvers, a paramagnetic ring with a special shape is attached to the shaft and rotates within an assembly array of two sets of coils; this requires precise positioning. However, due to the necessary precise alignment of the components, these systems can lead to corresponding costs during assembly and maintenance. Inductive systems, which may consist of a multilayer printed circuit board with coils and an electrically conductive rotor, likewise require precise alignment and a certain minimum size, which may increase the installation space and the associated costs. A further disadvantage is that both resolvers and inductive systems are sensitive to mechanical tolerances, which can impair the accuracy of the angle measurement.

Based on this, there is a need for a system that counteracts these limitations and enables precise angle measurement with minimal space requirement and lower costs, while at the same time offering high resistance to external interference such as stray fields.

### SUMMARY

This need is addressed by apparatuses and methods according to the independent patent claims. Advantageous developments emerge from the dependent claims.

According to a first aspect of the present disclosure, an apparatus for determining the angle of a rotating shaft is proposed. The apparatus includes a permanent magnet which has at least one magnetic pole pair and is fastened to the rotating shaft, and at least two magnetic sensor devices which are spaced apart from one another. The sensor devices are arranged around the shaft at a pole-pair-dependent angular offset from one another and each include at least two magnetic-field-sensitive elements that generate differential output signals. In addition, an evaluation unit is provided which is configured to receive the differential output signals provided by the at least two sensor devices and determine angle information of the shaft therefrom. This device enables a precise (OoS) angle measurement by using differential signals, which can ensure high accuracy even in the presence of interference fields.

According to some implementations, the permanent magnet is formed as a two-pole magnet, wherein the at least two magnetic sensor devices are arranged around the shaft at an angular offset of 180°/2=90° from one another. If the permanent magnet is formed as a four-pole magnet (two pole pairs), then the magnetic sensor devices can be arranged around the shaft at an angular offset of 180°/4=45° from one another. In the case of a diametrical magnetization with only one pole pair (north and south pole), the optimum angular offset between the two magnetic sensor devices is 90°, since this corresponds to an electrical angle of 90°. If, on the other hand, the permanent magnet has two pole pairs (a total of four poles), then the optimum angular offset is correspondingly reduced to 45°, since the electrical angle now becomes smaller owing to the increased number of poles. One advantage of such an implementation with a plurality of pole pairs is that the sensors perceive magnetic field changes more frequently per mechanical revolution, which can increase the angular resolution. A smaller angular offset can furthermore enable a more compact and space-saving arrangement of the sensors. At the same time, the high interference field robustness is maintained due to the differential measurement. This flexibility in the arrangement of the sensor elements makes it possible to optimally adapt the apparatus to specific structural requirements and different geometric boundary conditions.

According to some implementations, the permanent magnet can be in the form of a ring or a disk. A ring-shaped or disk-shaped permanent magnet for measuring angles can be magnetized diametrically or in multipolar fashion, wherein the poles are arranged in segments along the circumference or the disk surface such that the field lines in each case run between opposite north and south poles. This generates clearly defined, locally varying magnetic fields which are ideal for determining the angular position of the shaft by surrounding magnetic-field-sensitive sensor elements. One advantage of these two alternative designs is that they allow flexible adaptation of the apparatus to different mechanical requirements. The ring-shaped or disk-shaped implementation can reduce a required installation height and thus facilitate a more compact and space-saving integration into existing systems, for example in applications with limited installation space or high demands on the overall system design. In addition, the magnetic shape can be selected in a targeted manner depending on the desired magnetic field distribution in order to achieve optimum measurement results with regard to accuracy and robustness vis-à-vis external interference fields.

According to some implementations, each of the magnetic sensor devices includes two magnetic field sensors, which each are in the form of xMR or VHall sensor elements, xMR refers to magnetoresistive sensor technologies in which the electrical resistance of a material changes when exposed to an external magnetic field. There are various types of magnetoresistive effects which are utilized in sensors, including anisotropic magnetoresistance (AMR), giant magnetoresistance (GMR), tunnel magnetoresistance (TMR) and extraordinary magnetoresistance (EMR). These technologies provide precise measurements of magnetic fields and can be used in angle and position measurement applications. VHall refers to vertical Hall effect sensors. The Hall effect describes the phenomenon whereby a magnetic field generates a voltage in a conductor through which current flows, with this voltage being perpendicular to the current flow and to the magnetic field. VHall sensors are specially configured Hall effect sensors that provide sensitivity to magnetic fields in vertical rather than traditional horizontal configurations. This type of sensor can be used in applications where it is important to accurately sense magnetic fields in specific orientations. Both sensor technologies offer robust and accurate possibilities for sensing magnetic fields.

According to some implementations, the at least two magnetic sensor devices have the same radial distance from the permanent magnet. This means that the at least two magnetic sensor devices are each positioned at the same distance from the centre of the permanent magnet, e.g., have the same distance from the axis of rotation of the shaft. As a result, both sensors are located on a common annulus, the centre of which forms the axis of the permanent magnet or of the shaft. The advantage of such a symmetrical arrangement is that both sensor devices are influenced in the same way by the magnetic field. As a result, they experience virtually identical changes in the case of external interfering influences, such as homogeneous stray magnetic fields, and these changes effectively compensate one another when the difference between the output signals is formed. Thus, the robustness of the angle measurement vis-à-vis external disturbances can be considerably improved, which in turn can increase the accuracy and reliability of the system. In addition, this symmetrical positioning can reduce possible offset effects and signal distortions, and this can further improve the accuracy and reproducibility of the measurement results.

According to some implementations, the at least two magnetic-field-sensitive elements within the magnetic sensor devices are each arranged in one plane which extends either parallel or perpendicular to the shaft axis. This means that the magnetic-field-sensitive sensor elements can be spatially positioned in two different ways. They can be arranged either in a plane which lies parallel to the axis of rotation of the shaft (axial arrangement), or in a plane which runs perpendicular to the shaft axis (radial or tangential arrangement). In the case of a parallel alignment with respect to the shaft axis (axial arrangement), the sensor elements primarily sense the axial magnetic field generated along the axis of rotation. This arrangement has the advantage that the sensor elements, owing to their symmetrical positioning vis-à-vis the axis, can offer a particularly high robustness vis-à-vis homogeneous stray magnetic fields. In this case, external magnetic fields act in the same way on both sensor elements, and so these interfering influences effectively cancel one another out when the difference between the signals is formed. By contrast, an arrangement of the sensor elements in a plane which runs perpendicular to the shaft axis (radial or tangential arrangement) means that the elements measure the magnetic field along the circumference or radially to the axis. This alignment enables a particularly compact integration, for example if the axial installation space is limited. However, in this arrangement the interference field suppression could be somewhat lower, since sensor elements, depending on the radial or tangential distance, may be exposed to magnetic fields of different strength or external stray fields. The choice between these two alignments thus offers the possibility of flexibly adapting the apparatus to different mechanical boundary conditions, space requirements and requirements with regard to interference field robustness.

According to some implementations, the at least two magnetic-field-sensitive elements thus within the magnetic sensor devices are each arranged axially spaced in one plane which extends parallel to the shaft axis. This means that the at least two magnetic-field-sensitive elements are positioned in a plane which is aligned parallel to the axis of rotation of the shaft, wherein there is an axial distance along the shaft axis between the elements. In other words, the sensor elements are located next to one another in one plane which extends longitudinally with respect to the axis but are not arranged exactly at the same axial position; instead, they are arranged axially offset with respect to one another. One advantage of this axially offset arrangement is that both sensor elements are exposed to a comparable magnetic field strength, which results in a symmetrical field distribution. Due to this symmetry, both elements are exposed to identical external interference fields, as a result of which homogeneous interference fields are effectively eliminated when the differential signals are formed. This axial arrangement can thus considerably improve the robustness and accuracy of the angle measurement with respect to external magnetic fields. In addition, this symmetrical arrangement can simplify the signal evaluation since the ideal case requires no additional corrections which might be necessary in the case of asymmetrical arrangements. This can result in higher accuracy, better reproducibility of the measurement results and simplified calibration and maintenance.

According to some implementations, the at least two magnetic-field-sensitive elements within the magnetic sensor devices are each arranged radially spaced in one plane which extends perpendicular to the shaft axis. This means that the at least two magnetic-field-sensitive elements in the magnetic sensor devices are positioned in a plane which extends perpendicular to the axis of rotation of the shaft, wherein the magnetic-field-sensitive elements have different radial distances from the centre of the shaft or from the permanent magnet. In other words, the magnetic-field-sensitive sensor elements are located in the same horizontal plane around the shaft but not on the same radius; instead, they are on different radii. A possible advantage of this arrangement is that this results in additional degrees of freedom with regard to the mechanical construction and positioning of the sensor elements. In this way, the system can be adapted more flexibly to various mechanical boundary conditions and space requirements. For example, one magnetic-field-sensitive element could be placed closer to the shaft to sense a stronger magnetic field component, while the other magnetic-field-sensitive element is positioned further away to detect another field component or field strength. This allows a targeted measurement of the radial magnetic field gradients but can simultaneously represent a challenge, since the elements are exposed to different magnetic field strengths on account of the different radial distances. In order to compensate for resultant differences in the signal amplitude or potential offset values, a subsequent normalization or calibration of the signals in the evaluation unit may be necessary. In comparison with the axial arrangement, in which the elements are positioned radially at the same distance from the shaft and symmetrically with respect to the latter, the radially different arrangement can offer somewhat less protection against external interference fields, since an asymmetrical field distribution is produced. Nevertheless, this implementation can allow greater flexibility in the structural design of the apparatus and adaptability to specific measurement conditions.

Subsequent normalization or calibration may also be necessary in the case of the axial arrangement. Even in the case of an ideal, symmetrical magnetic field, different signal amplitudes from the two sensor devices may occur, e.g., on account of production-related different sensitivities of the xMR (e.g., TMR) elements.

According to some implementations, the magnetic-field-sensitive elements within the magnetic sensor devices are each arranged tangentially spaced in one plane which extends perpendicular to the shaft axis. This describes an arrangement in which the magnetic-field-sensitive elements of the sensors lie in a plane which is positioned perpendicular to the axis of rotation of the shaft. In this case, the sensor elements are tangentially spaced apart from one another, e.g., are arranged offset from one another by a specific angle along the circumference of a circle around the shaft or permanent magnet. This means that both sensor elements may have the same distance from the shaft axis when viewed radially but are spatially separated from one another along the circumference of the circle, e.g., in the tangential direction. One advantage of this tangential arrangement is that the sensors sense the change in the magnetic field from different tangential positions. This results in phase-shifted sensing of the magnetic field components, which can in turn be used to determine the angular position. This tangential placement allows a targeted measurement of field changes, which can occur particularly markedly along the circumferential direction. This offers advantages in particular in situations in which an axial arrangement is not possible or not desired due to structural limitations. However, the tangential positioning, similar to the radial arrangement, may be more susceptible to external magnetic interferences, in particular whenever ferromagnetic components amplify the external magnetic field. Despite this possible disadvantage, the tangential arrangement allows flexible integration of the sensors in the event of limited axial installation space, and so the apparatus can be used more widely in different structural and technical environments.

According to some implementations, the shaft belonging to the apparatus is not ferromagnetic. This means that the shaft consists of a material which has no ferromagnetic properties and is therefore not magnetic. Typical materials for this purpose for example include aluminium, stainless steel or other non-magnetic metals and alloys. One advantage of this choice of material is that the shaft does not amplify or influence the magnetic field since there is no magnetic flux concentration or magnetic flux distortion. As a result, the magnetic field sensed by the magnetic sensor elements remains homogeneous and undistorted, and this can increase the accuracy and stability of the angle measurement. In addition, a non-ferromagnetic shaft can facilitate a calibration of the sensors, since less compensation outlay owing to interfering magnetic influences is required. This can ultimately improve the measurement accuracy and reduce the outlay for calibration and maintenance of the apparatus.

According to a further aspect of the present disclosure, a method for determining the angle of a rotating shaft is proposed. The method includes fastening a permanent magnet which has at least one magnetic pole pair to the rotating shaft and arranging at least two magnetic sensor devices around the shaft at pole-pair-dependent angular offsets. The method includes sensing differential output signals by the at least two magnetic sensor devices and evaluating the signals to determine the angle, thereby creating an effective possibility of achieving precise and continuous angle tracking of rotating components in various industrial applications.

According to a further aspect, the present disclosure provides an apparatus for determining the angle of a rotating shaft. The apparatus includes a permanent magnet which has at least one magnetic pole pair and is fastened to the rotating shaft. The device furthermore includes at least three magnetic field sensors arranged around the permanent magnet with equidistant angular spacing. Each magnetic field sensor is configured to sense a magnetic field generated by the permanent magnet and output a corresponding sensor signal. The apparatus furthermore includes an evaluation unit. The evaluation unit is configured to receive the sensor signals from the at least three magnetic field sensors. The evaluation unit derives a sine signal and a cosine signal from the sensor signals using a transformation. The evaluation unit calculates angle information of the shaft based on the sine signal and the cosine signal.

A plurality of magnetic field sensors, which are distributed uniformly around a rotating magnet, thus jointly measure the magnetic field generated by the magnet. With the aid of a mathematical transformation, a computing unit converts the measured values thus obtained into a sine signal and a cosine signal, from which the exact rotation angle of the shaft can be derived. This arrangement allows angles to be captured without mechanically complicated alignment of an individual sensor. The proposed apparatus can enable a precise 360° absolute angle measurement. The equidistant arrangement of at least three magnetic field sensors makes it possible to reduce magnetic-field-related errors, as occur in arrangements with fewer sensors. The apparatus can also enable a more robust measurement vis-à-vis interference fields and stray fields.

According to some example implementations, each magnetic field sensor is configured to sense a radial component of the magnetic field generated by the permanent magnet. Hence, no sensor measures the entire magnetic field; instead, each sensor specifically measures that component which points outwards perpendicular to the axis of the shaft, e.g., in the radial direction. This directed sensing ensures that the magnetic field information relevant to the angle calculation is evaluated selectively. Sensing the radial magnetic field component can improve the angular accuracy, since magnetic interfering influences in other spatial directions can be suppressed. As a result, the measurement can become more stable and less susceptible to axial or tangential stray fields.

According to some example implementations, the permanent magnet is diametrically magnetized. This means that the magnetization direction of the permanent magnet runs transversely through the entire magnet, with the result that a north pole and a south pole are diametrically opposite one another. The generated magnetic field also rotates when the magnet rotates, and this generates a sinusoidal signal variation at each measurement point. The diametrical magnetization can produce a uniform and readily predictable magnetic field characteristic. This can improve the quality of the derived sine and cosine signals and thus increase the accuracy of the angle calculation.

According to some example implementations, the transformation is a Clarke transformation. The Clarke transformation is a mathematical method which converts signals from a three-phase system into a two-dimensional coordinate system and directly generates an orthogonal sine-cosine pair in the process. The use of the Clarke transformation can enable a computationally efficient derivation of the angle information from the sensor signals. It can also contribute to filtering out DC components and in-phase interference signals from the sensor signals.

According to some example implementations, the magnetic field sensors are in the form of TMR sensors. The use of TMR sensors can enable precise and low-noise sensing of the magnetic field. This can contribute to a higher angular resolution and an improved measurement accuracy even in the case of weak magnetic fields, for example in the case of large air gaps.

According to some example implementations, each magnetic field sensor is in the form of a differential sensor with two magnetic-field-sensitive measuring elements. Each magnetic field sensor is configured to form a difference signal from the measurement signals from its two measuring elements. This means that two measuring elements within a sensor sense the magnetic field at two points close to one another. The output signal of the sensor is formed from the difference between these two measurement signals. The differential signal evaluation can contribute to the effective suppression of in-phase interference signals which may arise due to external stray fields or temperature drifts, for example. The measurement sensitivity vis-à-vis the useful signal can be maintained, while the signal-to-noise ratio can be improved.

According to some example implementations, the two magnetic-field-sensitive measuring elements of each magnetic field sensor are arranged such that either an axial component of the magnetic field generated by the permanent magnet is sensed differentially, wherein a chip plane of each magnetic field sensor is aligned substantially parallel to the surface of the shaft or of the permanent magnet, or a tangential component of the magnetic field generated by the permanent magnet is sensed differentially, wherein the magnetic-field-sensitive measuring elements are spaced apart from one another along a tangent on the circumference of the shaft and are arranged at the same radial distance from the axis of the shaft. Thus, either the axial or the tangential magnetic field component can be sensed selectively and differentially, depending on the geometric arrangement of the measuring elements. This allows flexible adaptation of the sensor configuration to different installation situations and magnet geometries. This flexibility in the sensor arrangement can improve the adaptability of the system to various mechanical constructions. The robustness with respect to stray fields can be further increased using the differential sensing of a defined magnetic field direction.

According to some example implementations, exactly three magnetic field sensors are provided and arranged with an angular spacing of 120° from one another around the permanent magnet. Three uniformly distributed sensors form a symmetrical three-phase system to which the Clarke transformation can be applied directly. An arrangement of three sensors can represent a good compromise between system complexity and measurement accuracy. Compared to a two-sensor arrangement, the angle error can be reduced.

According to some example implementations, exactly six magnetic field sensors are provided and arranged with an angular spacing of 60° from one another around the permanent magnet. This arrangement with six sensors represents an extension of the three-sensor arrangement and can further increase the angular accuracy by redundancy and averaging. A six-sensor arrangement can further reduce the angle error vis-à-vis a three-sensor arrangement. The spatially distributed sensing of the magnetic field can effectively compensate for magnetic-field-related inhomogeneities of the permanent magnet.

According to some example implementations, the evaluation unit is furthermore configured to calculate three intermediate signals, wherein each intermediate signal is formed from the difference between the sensor signals from two opposing magnetic field sensors. The transformation is applied to these three intermediate signals. In the case of a six-sensor arrangement, the signals from two opposing sensors are subtracted in each case before the Clarke transformation is applied. The preceding subtraction can bring about an additional suppression of common-mode interference signals. It can also increase the signal amplitude and thus improve the dynamic range of the subsequent transformation.

According to some example implementations, the permanent magnet is a ferrite magnet. Ferrite magnets consist of a ceramic material based on iron oxide and are inexpensive, corrosion-resistant and temperature-stable. The use of a ferrite magnet can reduce the manufacturing cost of the system. Ferrite magnets can be used in industrial environments where temperature resistance and chemical robustness are required. Their lower remanence in comparison with rare-earth magnets can be compensated for by suitable sensor selection and system design.

According to some example implementations, the permanent magnet is in the form of a ring or a disk. Both shapes permit coaxial, mechanically simple fastening to the rotating shaft and are well suited for diametrical magnetization. A ring-shaped or disk-shaped magnet geometry can promote a uniform magnetic field distribution in the outer region. In addition, it can enable a simple and space-saving integration into existing shaft constructions.

According to some example implementations, the magnetic field sensors are arranged radially outside the permanent magnet. The sensors are therefore not located above or below the magnet but on its outer circumference, at uniform angular distances around the shaft. A radially outer sensor arrangement can enable mechanically flexible mounting on a printed circuit board which surrounds the shaft. In addition, this arrangement can provide easy access to the sensors for maintenance and calibration.

According to some example implementations, an air gap between the permanent magnet and the magnetic field sensors is greater than 3 mm. The air gap denotes the clear distance between the outer surface of the permanent magnet and the active surface of the magnetic field sensors. A sufficiently large air gap can contribute to the magnetic field sensors being operated within their linear measurement range. Excessively strong magnetic fields can drive the sensors into saturation and lead to increased angle errors.

According to some example implementations, the evaluation unit is furthermore configured to carry out a calibration. The calibration may include normalizing the sensor signals by way of offset correction and amplitude correction. As an alternative to that, or in addition, the calibration can include fitting an ellipse to extract correction factors Ellipse fitting analyses the sine and cosine signals and corrects deviations from the ideal circular shape to reduce systematic angle errors. A calibration function can improve the measurement accuracy of the system. By correcting offset and amplitude errors, manufacturing tolerances and assembly errors can be compensated for. Ellipse fitting can contribute to correcting non-linear magnetic field properties and sensor mismatches in particular.

According to some example implementations, the evaluation unit is configured to calculate the angle information from the sine signal and the cosine signal using an atan 2 function. The atan 2 function is a variant of the arctangent function which unambiguously covers the complete angular range from 0° to 360° and takes into account the sign of both input signals. Use of the atan 2 function can ensure a unique 360° absolute angle detection. In contrast with the simple arctangent function, ambiguities in the angle assignment can be avoided, which is essential for a reliable angle determination over the full revolution.

According to some example implementations, the shaft is not ferromagnetic. This means that the shaft material has no magnetic properties or only negligible magnetic properties and therefore does not influence or distort the magnetic field of the permanent magnet. A non-ferromagnetic shaft may prevent the magnetic field of the permanent magnet from being diverted or distorted by the shaft material. This can improve the quality of the measurement signals and increase the accuracy of the angle determination.

According to some example implementations, the apparatus includes a number N=3 k (k≥2) of magnetic field sensors arranged around the shaft with a uniform angular spacing of 360°/N. The evaluation unit is configured to divide the N magnetic field sensors into k subsets of three magnetic field sensors each, wherein the three magnetic field sensors of each subset are offset from one another by 120° in each case. The evaluation unit performs a Clarke transformation on the three associated sensor signals for each subset in order to obtain one sine signal and one cosine signal in each case. The evaluation unit determines a partial angle from each sine-cosine pair using an arctangent function. The evaluation unit calculates the final rotation angle of the shaft as the mean value of the k partial angles. In other words: In the case of an arrangement having, for example, six, nine or twelve sensors, these are divided into groups of three sensors each. Each group supplies its own angle value. The final angle results from the average of all partial angles. This represents a scalable extension of the basic three-sensor arrangement. This scalable architecture can systematically improve angular accuracy as the number of sensors increases. The averaging over a plurality of independent angle measurements can reduce random measurement errors and sensor-specific deviations. The concept can also enable simple redundancy for safety-relevant applications.

According to a further aspect, the present disclosure provides a method for determining the angle of a rotating shaft. The method includes sensing a radial, an axial or a tangential magnetic field component using at least three magnetic field sensors which are arranged with equidistant angular spacing around a diametrically magnetized permanent magnet that is fastened to the shaft. Each magnetic field sensor outputs a corresponding sensor signal. The method further includes deriving a sine signal and a cosine signal from the sensor signals of the at least three magnetic field sensors using a transformation. Finally, angle information of the shaft is calculated based on the sine signal and the cosine signal.

According to a further aspect, the present disclosure provides an angle measurement system for 360° absolute angle detection. The system includes a rotatable shaft and a diametrically magnetized permanent magnet rotationally conjointly connected to the shaft. A printed circuit board is arranged stationarily relative to the shaft. At least three magnetic field sensors are mounted on the printed circuit board with equidistant angular spacing around the permanent magnet, wherein each magnetic field sensor is configured to sense a radial magnetic field component. A processor receives the sensor signals from the at least three magnetic field sensors, derives a sine signal and a cosine signal using a transformation and calculates an absolute angle value of the shaft. The angle measurement system can be realized as a complete, self-contained unit for industrial applications. The integration of all components on a printed circuit board can enable a compact and cost-effective system solution.

According to a further aspect, the present disclosure provides a computer program product including instructions which, when executed by a processor, cause the processor to receive sensor signals from at least three magnetic field sensors arranged with equidistant angular spacing around a diametrically magnetized permanent magnet. Furthermore, the processor is caused to derive a sine signal and a cosine signal from the sensor signals using a transformation and calculate angle information based on the sine signal and the cosine signal.

A person skilled in the art will recognize that the example implementations and features described above are not restricted to the respective combination described but can be combined with one another in a variety of ways. Thus, for example, features of the example implementations relating to the number and arrangement of the magnetic field sensors can be combined with features relating to the configuration of the magnetic-field-sensitive elements, the type of transformation or the calibration methods. Likewise, example implementations that describe a three-sensor arrangement with a Clarke transformation can be combined with example implementations that provide differential signal acquisition, ellipse fitting or a specific magnet geometry. Features of the first aspect relating to the apparatus with at least two magnetic sensor devices and pole-pair-dependent angular offset can be combined with features of the second aspect relating to the apparatus with at least three equidistantly arranged magnetic field sensors and a transformation, provided that this is technically expedient and not contradictory. The present disclosure is therefore not limited to the combinations explicitly described but rather encompasses all technically realizable combinations of the disclosed features.

A person skilled in the art will discern further features and advantages of the implementation upon reading the following detailed description and examining the attached drawings.

### BRIEF DESCRIPTION OF THE DRAWINGS

The present disclosure is shown in an example and non-limiting manner in the illustrations of the attached drawings, in which identical reference numbers refer to similar or identical elements. The elements in the drawings are not necessarily depicted to scale in relation to each other. The features of the various examples shown can be combined, provided that they are not mutually exclusive.

FIG. 1 shows an axial arrangement of two sensor devices with axially spaced apart magnetic-field-sensitive elements which are at the same radial distance from the rotating shaft and thus provide high stray field robustness;

FIG. 2A shows an implementation in which the magnetic-field-sensitive elements are radially at different distances from the centre of the shaft and are arranged in one plane which runs perpendicular to the axis of rotation;

FIG. 2B shows a tangential arrangement of the magnetic-field-sensitive elements which are located at the same radial height but tangentially offset in one plane perpendicular to the axis of rotation;

FIG. 3 shows a comparison of all three arrangements (axial, radial and tangential) with their different spatial positions of the magnetic sensor elements;

FIG. 4 shows detailed measurement results of the axial sensor arrangement with a high interference field robustness and low measurement error over a full revolution of the shaft;

FIG. 5 shows detailed measurement results of the radial sensor arrangement, which has reduced robustness vis-à-vis stray fields owing to different radial distances of the sensor elements;

FIG. 6 shows detailed measurement results of the tangential sensor arrangement, in which there is a slightly reduced robustness vis-à-vis magnetic interference fields owing to tangentially offset sensor elements;

FIG. 7 shows an implementation of an apparatus having three equidistantly arranged magnetic field sensors; and

FIG. 8 shows an implementation of an apparatus having six equidistantly arranged magnetic field sensors.

### DETAILED DESCRIPTION

Known solutions for out-of-shaft (OS) angle measurement include magnetic and inductive solutions. The magnetic solution is based on an arrangement of two linear sensors that utilize either Hall or xMR technology and can be aligned at an angle of 90° to one another. In this case, a first sensor generates a sine signal, and a second sensor generates a cosine signal, as a result of which an angular position of the shaft can be calculated, for example with the aid of an ATAN2 function. However, owing to the mono-cell concept used, this solution has little robustness vis-à-vis stray fields.

The inductive solution uses a static printed circuit board design with one transmitter coil, two receiver coils and an electrically conductive rotor. However, this system requires a complex mechanical construction, since the coils and the rotor must be arranged around the shaft. In addition, miniaturization is limited due to low signal strengths (SNR), which necessitates the use of large diameters or multilayer printed circuit boards in order to ensure adequate inductance.

The implementations described below extend existing magnetic solutions for (OoS) angle measurement using a differential sensor concept. In this case, a permanent magnet is combined with two differential magnetic sensor devices which are arranged at a pole-pair-dependent angle (of e.g., 45° or) 90° with respect to one another. This concept uses either xMR or Hall sensors and enables improved signal processing by acquiring differential signals. An axial measuring arrangement is advantageous since it offers high sensitivity and improved suppression of interference fields. The described implementations can outperform conventional systems in terms of performance and interference field robustness, which is achieved in particular by suppressing homogeneous interference fields. A further advantage is a reduction of the signal distortion due to non-linear effects in the sensors. The proposed concept is also suitable for an efficient implementation with existing sensor technologies, which allows easy integration into industrial applications.

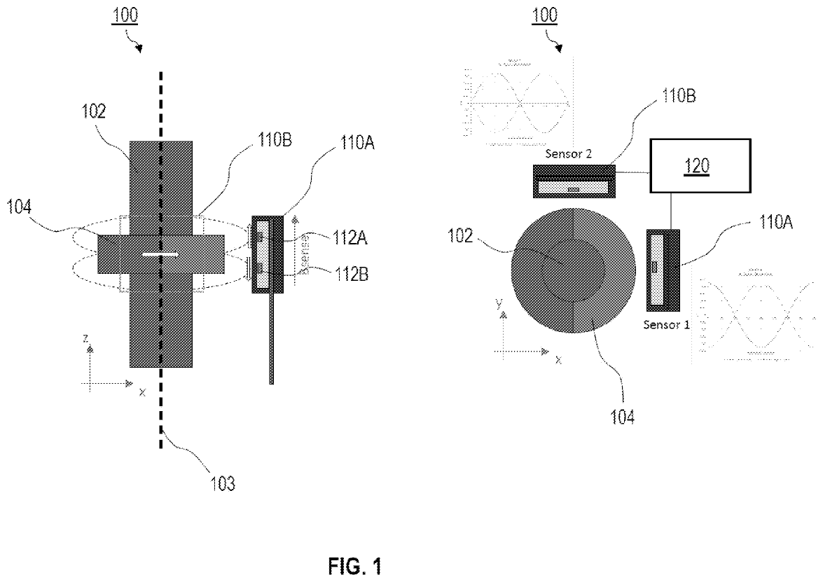

FIG. 1 shows an apparatus 100 according to one example implementation for determining the angle of a rotating shaft 102 (e.g., a rotatable shaft).

The apparatus 100 comprises a permanent magnet 104 which has at least one magnetic pole pair and is fastened to the rotating shaft 102. The permanent magnet 104 can be embodied in different geometric implementations, in particular in the form of a ring magnet or disk magnet. FIG. 1 shows a ring-shaped permanent magnet 104 which completely encloses the shaft 102 in the radial direction. Such a ring magnet is advantageous if the intention is to arrange the components around the shaft 102 in a space-saving and compact manner, since it allows the shaft 102 to run centrally through its middle and thus requires only little additional axial installation space. By contrast, a disk-shaped permanent magnet would typically be mounted on an end face of the shaft 102. In this case, the disk would not rest around the shaft 102 but instead rest axially against the end of the shaft such that the magnetic field would mainly be oriented in the axial direction. As a result, hardly any additional radial space is required, but somewhat more installation space is required in the axial direction along the shaft 102. In terms of the number of magnetic pole pairs, the permanent magnet 104 may have either two magnetic poles (one pole pair) or a plurality of pole pairs, for example four magnetic poles (two pole pairs). Furthermore, the shaft 102 to which the permanent magnet 104 is fastened may consist of different materials. For example, the shaft 102 may be made of a ferromagnetic material, such as steel, as a result of which it amplifies and focuses stray magnetic fields. However, this can lead to challenges as regards the measurement accuracy, since these amplified stray fields can lead to undesired signal influences on the magnetic-field-sensitive elements. Alternatively, however, the shaft 102 may also consist of non-ferromagnetic materials, for example aluminium or non-magnetic stainless steel. Such materials do not attract magnetic fields and do not amplify these either, and so external magnetic influences are better controlled, and the measurement results are more precise and more easily reproducible. In addition, the use of non-ferromagnetic materials optionally allows weight to be saved and improved corrosion resistance.

Furthermore, the apparatus 100 comprises at least two magnetic sensor devices 110A, 110B which are spaced apart from one another, which are each arranged around the shaft 102 at a pole-pair-dependent angular offset from one another and which each comprise at least two magnetic-field-sensitive elements 112A, 112B that generate differential output signals. The magnetic sensor devices 110A, 110B can be realized in accordance with various implementations, wherein each sensor device 110A, 110B preferably comprises two magnetic-field-sensitive elements 112A, 112B. These magnetic-field-sensitive elements 112A, 112B for example are in the form of magnetoresistive (xMR, in particular TMR, AMR or GMR) elements or Hall elements (in particular vertical Hall elements, VHALL). The magnetic-field-sensitive elements 112A, 112B may be configured either as individual resistances or alternatively in a Wheatstone bridge circuit to generate differential output signals with high accuracy and improved interference field protection. The angular offset between the magnetic sensor devices 110A, 110B depends on the number of pole pairs of the permanent magnet 104 used. Thus, the angular offset in the case of a two-pole magnet (e.g., one pole pair) is typically 90°, since this corresponds to an electrical angle of 90°, wherein one sensor device 110A is positioned at the centre of a pole and the other sensor device 110B is positioned at the pole transition. If, on the other hand, the permanent magnet 104 has a plurality of pole pairs, for example four poles (two pole pairs), the angular offset is reduced proportionally to 45°. An advantage of a smaller angular offset lies in a more compact arrangement of the sensors and a higher angular resolution, since a plurality of signal periods can be acquired per mechanical revolution.

The magnetic-field-sensitive elements 112A, 112B within the sensor devices 110A, 110B may be arranged in various ways. In a preferred implementation, which is shown in FIG. 1, the two magnetic-field-sensitive elements 112A, 112B are arranged axially spaced apart in a plane parallel to a shaft axis 103 (e.g., an axial shaft axis), as a result of which they experience the same magnetic conditions, and hence optimum conditions are created for differential signal evaluation. Alternatively, the magnetic-field-sensitive elements 112A, 112B can be arranged radially spaced apart in one plane which extends perpendicular to the shaft axis 103 or else be positioned tangentially spaced apart along the circumference of the permanent magnet 104 in a plane which extends perpendicular to the shaft axis 103. These alternative arrangements offer advantages in relation to mechanical flexibility, enable a more compact construction and allow adaptations to specific requirements of the respective application.

The apparatus 100 comprises an evaluation unit 120 which is configured to receive the differential output signals provided by the at least two sensor devices 110A, 110B and determine angle information of the shaft 102 therefrom. The evaluation unit 120 of the apparatus 100 serves for processing and evaluating the differential signals supplied by the magnetic sensor devices 110A and 110B in order to determine the angular position of the rotating shaft 102 therefrom. This evaluation unit can be embodied in a plurality of technological variants, for example as an application-specific integrated circuit (ASIC), as a programmable microcontroller or alternatively as a field-programmable gate array (FPGA).

In an implementation as an ASIC, the differential signals generated by the magnetic-field-sensitive elements 112A, 112B may be received and directly processed internally. In this case, the ASIC can perform signal processing by correcting (orthonormalizing) offset errors, phase errors and amplitude errors, for example, and then calculating an exact angular position of the shaft using mathematical operations such as the ATAN2 function. An ASIC offers the advantage of particularly compact, energy-efficient and fast processing, which has particularly proven its worth in industrial applications with high demands on robustness and real-time capability.

Alternatively, the evaluation unit 120 can be realized as a microcontroller, which digitizes the differential output signals from the sensors and subsequently processes them in software. The microcontroller can first perform a calibration of the sensor signals by correcting offsets and phase and amplitude deviations (orthonormalization). Thereafter, it can calculate the exact angular position of the shaft 102 with the aid of mathematical algorithms, typically the ATAN2 function. This solution allows a high degree of flexibility in terms of adaptations to different sensors and applications and also offers the possibility of supplementing further functions later using software updates.

When implemented as an FPGA, the sensor signals can be processed by individually programmable logic structures. Due to its parallel and high-performance signal processing, an FPGA enables fast and at the same time flexible signal processing. As a result of this parallel processing possibility, an FPGA-based evaluation unit is particularly suitable for complicated real-time applications, in which multiple sensor signals have to be processed simultaneously, or in the case of very high demands on speed and adaptability.

Irrespective of the specific implementation, the evaluation unit 120 can perform orthonormalization of the sensor signals, which corrects offset, phase shifts and different signal amplitudes. As a result, the system can achieve high accuracy and reliable angle measurement, even under difficult conditions with external magnetic interference fields or mechanical tolerances.

The OoS system according to FIG. 1 comprises a diametrically magnetized ring magnet 104, which is fastened to the rotating shaft 102, and two differential sensor devices 110A, 110B, which are arranged at an angular offset of 90° with respect to one another. Each sensor device 110A, 110B consists of two sensor elements 112A, 112B (e.g., xMR or VHALL). These can be realized either as individual resistances or in a Wheatstone bridge configuration. The sensor elements 112A, 112B are sensitive to the magnetic field in the z-direction.

In a preferred implementation, the chip plane is aligned parallel to the upper or lateral surface of the shaft 102 (YZ-plane). As a result, the sensor devices 110A, 110B sense the axial magnetic field generated by the permanent magnet 104. The sensor output is a differential signal resulting from the difference between the first and second magnetic-field-sensitive elements 112A, 112B. In this way, homogeneous stray fields are suppressed. The sensor signals are transmitted to a microcontroller or ASIC 120, which performs an optional orthonormalization (correction of offset, phase and amplitude of the sensor signals for sine and cosine signals) and calculates the shaft angle therefrom.

The preferred implementation offers several advantages. One of the most important aspects is the increased robustness to stray fields. Both sensor elements 112A, 112B of the sensor devices 110A, 110B are located in a symmetrical magnetic field, and so they are exposed to the same absolute magnetic field strength. This improves the suppression of stray fields since possible sensitivity differences due to the non-linearity of TMR sensors are reduced. Moreover, on account of their high magnetic permeability, ferromagnetic shafts 102 act as flux concentrators and amplify stray magnetic fields. However, due to the symmetrical arrangement of the sensor elements 112A, 112B and their identical distance from the shaft 102, both sensor devices 110A, 110B are exposed to the same stray field influences, as a result of which interference effects are largely compensated for.

A further advantage results from the compact construction. The system can also be used for small-diameter shafts 102 and allows a reduction of the overall outer diameter in comparison with inductive systems. A feasibility study based on FEM simulations shows that for a shaft 102 with a diameter of 5 mm, a maximum module with a diameter of only 16 mm can be realized. By contrast, a comparable inductive system with the same mechanical dimensions achieves a lower measurement accuracy.

In addition, the preferred implementation offers a higher measurement accuracy compared to inductive systems, which is advantageous in particular in applications with high demands on precision.

In addition to the functional advantages, there are also cost advantages. Thanks to the high sensitivity of the TMR sensors, the system can also be operated with rare-earth-free magnets, such as ceramic magnets. This reduces material costs and allows more economical production of the system without impairing performance.

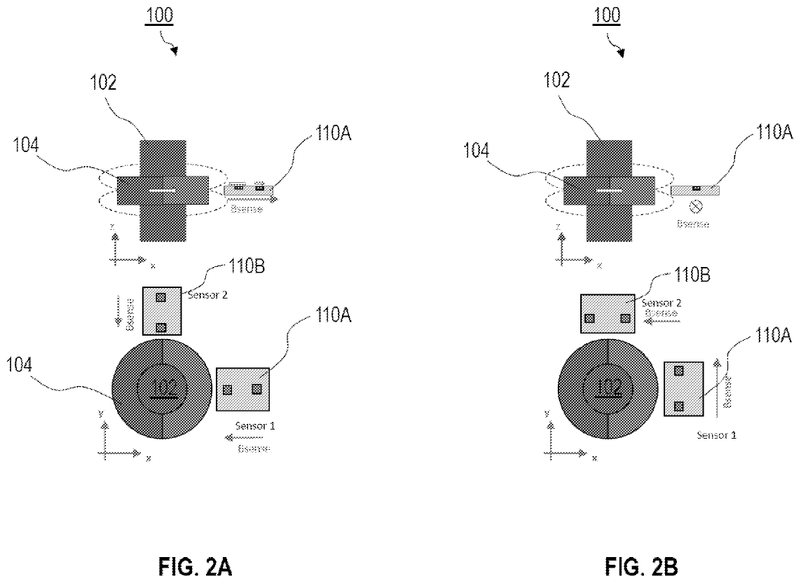

The apparatus 100 illustrated in FIG. 2A shows a further implementation of an angle measuring device for a rotating shaft 102.

The apparatus 100 again comprises a diametrically magnetized permanent magnet 104, which is fixedly connected to the shaft 102 and consequently rotates therewith. The permanent magnet 104 is configured such that it comprises two opposite magnetic poles (north and south poles). Two magnetic sensor devices 110A and 110B, each containing two magnetic-field-sensitive elements 112A, 112B, are positioned around the permanent magnet 104. These magnetic-field-sensitive elements 112A, 112B of the sensor devices 110A and 110B are positioned at different distances from the centre of the shaft 102 in the radial direction and are located in one plane (XY-plane) which extends perpendicular to the axis of rotation 103 of the shaft 102. The sensor device 110A with its two magnetic-field-sensitive elements is positioned to the right of the magnet 104 in the view shown, while the sensor device 110B is arranged above the magnet 104. Both sensor devices 110A, 110B have an angular offset of 90° (electrical angle) with respect to one another.

The two magnetic sensor apparatuses 110A and 110B detect magnetic field changes which are generated by the rotation of the diametrically magnetized permanent magnet 104. Due to their radially different positioning, the respective sensor elements 112A, 112B sense a magnetic field of different strength. Sensor device 110A primarily senses the magnetic field in the x-direction, while sensor device 110B primarily measures the magnetic field in the y-direction. This spatial arrangement produces a differential output signal (sine and cosine), from which the angular position of the shaft 102 can be precisely determined in a downstream evaluation unit (e.g., ASIC or microcontroller). This differential measurement makes it possible to effectively compensate for external homogeneous magnetic interference fields. However, differences in the signal strength and possibly increased influences of non-homogeneous magnetic fields can occur due to the radially offset arrangement of the magnetic-field-sensitive elements. These differences can be compensated for by subsequent signal normalization or calibration in the evaluation unit in order to ensure a reliable angle determination.

In contrast to this, in FIG. 1, the magnetic-field-sensitive elements 112A and 112B are radially equidistant from the permanent magnet 104, which leads to a symmetrical detection of the magnetic field. As a result, both magnetic-field-sensitive elements 112A and 112B are exposed to the same magnetic field gradient, which ensures a uniform signal strength and makes possible a better suppression of homogeneous interference fields. Such a symmetrical arrangement ensures that external magnetic interference fields largely cancel each other out, since they influence both sensors equally. This improves the interference field robustness and reduces the need for complex correction measures in the signal processing.

In summary, it can be the that different radial positioning of the magnetic-field-sensitive elements 112A, 112B (FIG. 2A) can result in increased signal distortion and lower interference field suppression, while the axial arrangement in FIG. 1 allows better interference field robustness and more precise measured values. However, depending on the application, radial differentiation in FIG. 2A can also be used in a targeted manner in order to sense specific field distributions or circumvent mechanical restrictions if the sensors cannot be placed at identical distances.

The apparatus 100 illustrated in FIG. 2B elucidates a further implementation for determining the angle of a rotating shaft 102 with the aid of two magnetic sensor devices 110A and 110B, which are positioned in one plane which extends perpendicular to the axis of rotation 103 of the shaft.

The apparatus 100 comprises a permanent magnet 104, which is diametrically magnetized and is fixedly connected to the rotating shaft 102. The two sensor devices 110A and 110B each have two magnetic-field-sensitive elements 112A and 112B which are arranged on a tangent to a circle around the shaft 102, wherein both sensor devices 110A, 110B have a defined angular offset of 90° from one another. The sensor device 110A is located on the right-hand side next to the permanent magnet 104, while the sensor device 110B is positioned above the magnet 104. The illustrated directions (Bsense) indicate which magnetic field components are primarily sensed by the respective sensor devices 110A (y-direction), 110B (x-direction).

The magnetic-field-sensitive elements 112A and 112B of the sensor devices 110A and 110B sense the changes in the magnetic field of the permanent magnet 104 which are generated by the rotation of the shaft 102. The tangential arrangement of the sensor elements 112A, 112B leads to magnetic field changes that occur along the circumference of the rotating magnet 104 being sensed. Since both sensor elements 112A, 112B within each sensor device 110A, 110B are tangentially offset from one another, they sense the magnetic field with a phase shift. In this case, the sensor device 110A primarily measures a vertical field component (in the direction of the y-axis), while the sensor device 110B primarily measures a horizontal field component (in the direction of the x-axis).

The offset tangential arrangement makes it possible to generate a differential output signal (consisting of sine and cosine signals), from which a connected evaluation unit 120 can precisely calculate the angular position of the shaft. However, by positioning the magnetic-field-sensitive elements 112A, 112B along a tangent, the sensitivity to interference fields may be somewhat increased, since external magnetic interferences may act to different extents along this tangent. This effect can be reduced by suitable signal processing, for example using calibration or orthonormalization in the evaluation unit. One advantage of this tangential arrangement is that it permits a particularly compact construction and can be flexibly integrated into applications with limited radial or axial installation space.

The implementations for radial (FIG. 2A) and tangential measurements (FIG. 2B) are likewise suitable for OoS angle measurement. However, the ability to suppress stray fields is slightly reduced in this case compared to the axial measurement (FIG. 1). Firstly, the radial measurement (FIG. 2A) is based on two sensor elements 112A, 112B with different radial air gaps. As a result, the sensor elements 112A, 112B are exposed to different magnetic offsets, which can restrict stray field suppression in the case of a non-linear TMR characteristic. Secondly, the stray field is attracted by the ferromagnetic shaft 102. Therefore, the magnetic-field-sensitive element 112A located closer to the shaft 102 is exposed to stronger stray fields than the magnetic-field-sensitive element 112B further away The tangential sensor arrangement (FIG. 2B) is also affected by the amplification of the stray field by the ferromagnetic shaft 102.

In one implementation, the shaft 102 may also consist of a non-ferromagnetic material, for example aluminium, copper or a non-magnetic stainless steel. Such a choice of material has several advantages in view of the suppression of stray field and the measurement accuracy of the system.

One advantage of a non-ferromagnetic shaft is that it does not amplify or distort any stray magnetic fields. In a ferromagnetic shaft, magnetic flux lines can be concentrated and diverted, and this can lead to a non-uniform magnetic field distribution in the vicinity of the magnetic sensor devices 110A and 110B. This can be problematic in particular in the case of radial or tangential sensor configurations, since the sensors are positioned at different distances from the shaft and as a result experience interference field influences of different strengths. A non-ferromagnetic shaft prevents this effect and ensures a more homogeneous magnetic field distribution around the shaft.

Moreover, a non-ferromagnetic shaft improves the reproducibility of the measured values since the magnetic field of the permanent magnet 104 is formed independently of an influence by the shaft material. As a result, sensor calibrations can be simplified, since no additional corrections are required for stray-field-induced signal deviations.

A further advantage results in relation to the choice of material and production costs. Non-ferromagnetic materials such as aluminium or certain plastics are often lighter than steel or other ferromagnetic metals, which may be advantageous in applications with high rotational speeds or strict weight limitations. In addition, in many cases they offer better corrosion resistance, which improves the long-term stability of the system.

The use of a non-ferromagnetic shaft 102 thus makes it possible to perform angle measurements which are more robust, more precise and less sensitive to interference fields overall; this is advantageous in particular in surroundings with strong external magnetic fields or high demands on signal stability.

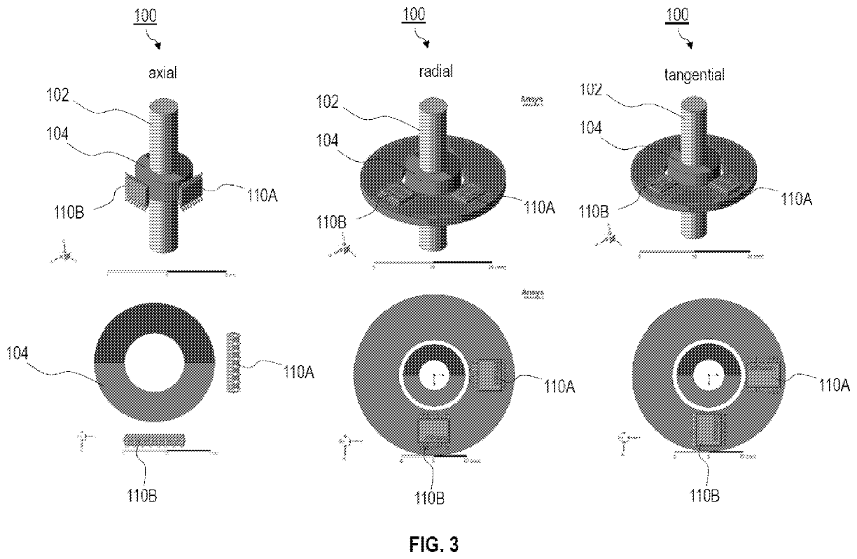

FIG. 3 shows three different implementations (axial, radial and tangential measurement) of an out-of-shaft (OoS) magnetic angle measuring device, consisting of a rotating shaft 102, a diametrically magnetized permanent magnet 104 fastened thereto and two magnetic sensor devices 110A and 110B.

The left-hand illustration shows an arrangement corresponding to FIG. 1, in which both sensor devices 110A, 110B are at the same radial distance from the centre of the shaft 102. Within each sensor device, the magnetic-field-sensitive elements 112A, 112B are axially spaced apart and primarily sense the axial magnetic field along the axis of rotation 103 of the shaft 102. This arrangement is distinguished in particular by its high interference field robustness, since both magnetic-field-sensitive elements can sense the magnetic field virtually identically and can effectively compensate for homogeneous external interference fields.

In the central illustration corresponding to FIG. 2A, both sensor devices 110A, 110B are likewise located radially at the same distance from the centre of the shaft 102 and are positioned in a plane which extends perpendicular to the axis of rotation. Here, however, within each sensor device, the magnetic-field-sensitive elements 112A, 112B are arranged at radially different distances from the centre of the shaft 102. This radial differentiation leads to the sensor elements sensing different magnetic field strengths. One advantage of this radial arrangement is that it offers greater flexibility in relation to mechanical integration. However, this gives rise to need for additional signal normalization or calibration in order to compensate for differences in the magnetic field strengths.

The right-hand illustration corresponding to FIG. 2B illustrates an arrangement in which both sensor devices 110A, 110B again are radially at the same distance from the shaft 102 and are positioned in a plane perpendicular to the axis of rotation. Within each sensor device, however, the magnetic-field-sensitive elements 112A, 112B are tangentially offset, e.g., they lie on a tangent to a circle around the shaft 102. As a result, they sense magnetic field changes along the circumference of the rotating shaft in a phase-shifted manner. This tangential arrangement is particularly suitable for enabling compact and space-saving constructions but can be more susceptible to external, inhomogeneous magnetic fields and therefore also requires suitable signal processing in order to compensate for such influences.

Overall, FIG. 3 thus represents three concrete implementations of the described system, which can be selected depending on the requirements for measurement accuracy, installation space, interference field robustness and integration possibility.

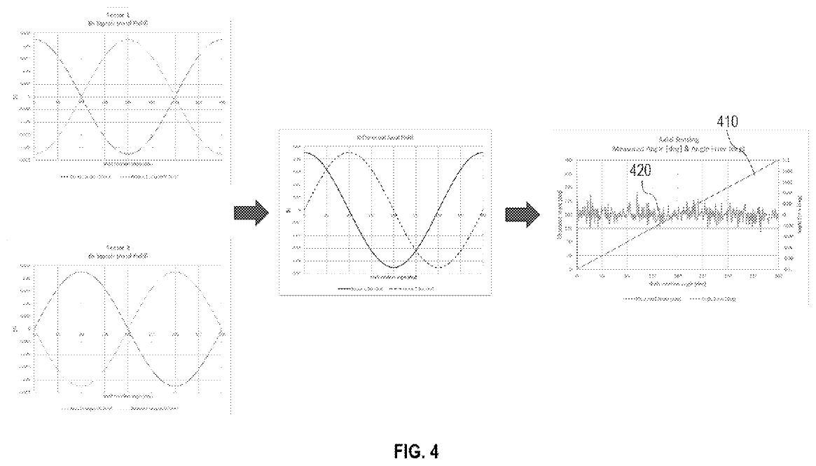

FIG. 4 shows in detail a mode of operation and advantages of the axial arrangement of the magnetic sensor elements 112A, 112B when the angle of a rotating shaft is measured.

The output signals of the two axially arranged magnetic sensor devices 110A, 110B (“Sensor 1” at the top and “Sensor 2” at the bottom) are illustrated in the left-hand region of FIG. 4. The curves represent the magnetic field (Bx component) which is generated by the permanent magnet 104 and varies sinusoidally over a full revolution of the shaft 102. It becomes clear here that both sensor devices 110A, 110B each have two measurement points (two magnetic-field-sensitive elements 112A, 112B), which acquire slightly different signals on account of their axial spacing.

In the middle region, FIG. 4 shows how a differential signal is generated by subtraction in each case from the individual signals of the two measurement points within each sensor device 110A, 110B. These differential signals (solid and dashed curves) are largely free of homogeneous magnetic interference fields and thus enable a more robust angle determination.

Finally, the accuracy of the measurement is shown on the right in FIG. 4. Curve 410 represents the measured angle over a full revolution of 360°, while curve 420 shows the measurement error occurring in degrees. An extremely small measurement error can be seen here, which lies in a narrow range close to zero. This demonstrates the high precision and robustness of the axial measurement method, in particular in relation to the suppression of interference fields and the minimization of errors that could arise as a result of non-linear properties (such as TMR non-linearity).

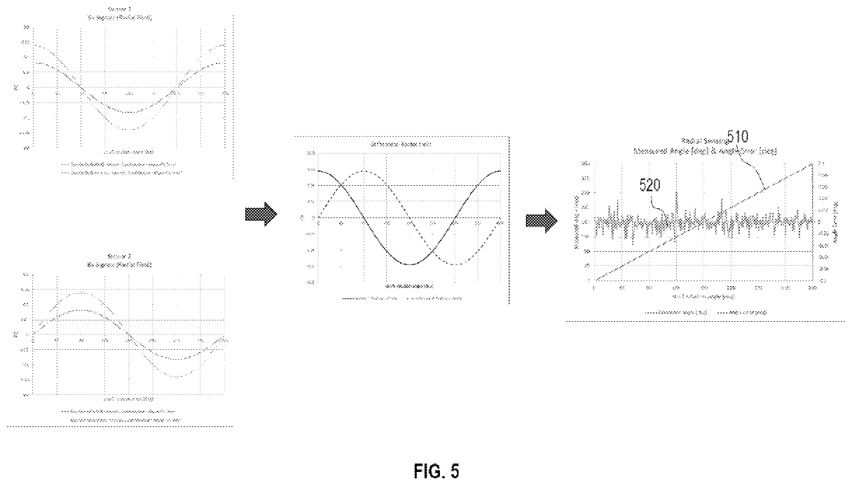

FIG. 5 shows an implementation of an out-of-shaft magnetic angle measurement system in which the magnetic-field-sensitive sensor elements 112A, 112B are positioned at different radial distances from the centre of the rotating shaft.

The left-hand side of FIG. 5 first shows the signals sensed by the two magnetic-field-sensitive elements 110A, 110B at different radial distances within the sensor devices 110A, 110B (“Sensor 1” at the top, “Sensor 2” at the bottom). The two different radial positions lead to each element being positioned at a different distance from the permanent magnet 104 and accordingly having different signal strengths (amplitude of the signals). The graphics clearly show that magnetic field signals of different strengths are generated in the case of different air gaps (e.g., 0.7 mm and a larger or smaller distance).

The central part of FIG. 5 illustrates how a differential output signal is formed by subtraction of the signals (“BxDown minus BxUp”) within each sensor device 110A, 110B. This subtraction leads to sinusoidal signals which are used to determine the rotation angle of the shaft 102.

The right-hand part of FIG. 5 illustrates the angle measurement over a full revolution of the shaft from 0° to 360°, together with the angle measurement error occurring in the process. Curve 510 shows the measured angle, while curve 520 indicates the associated measurement error in degrees. The measurement error is small here, confirming the fundamental suitability of this radial arrangement, but slight signal deviations occur, and these may be caused by the radially different positioning of the sensor elements.

The radial arrangement offers the advantage of increased flexibility in relation to mechanical integration, but the stray field suppression is somewhat reduced owing to the different radial distances of the sensor elements. This is due to the fact that the sensor elements are exposed to different magnetic field strengths, which could lead to reduced interference field suppression in the case of non-linear characteristics of the sensors used (for example TMR sensors). In practice, however, this can be compensated for by calibration or signal correction in the evaluation unit.

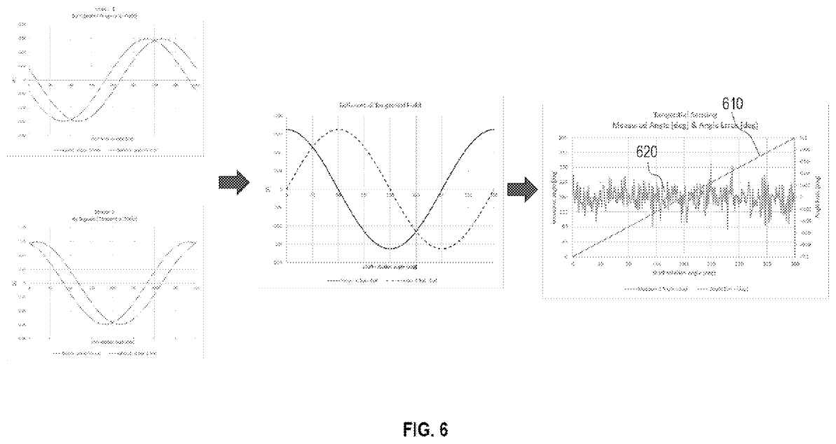

FIG. 6 shows an implementation of a magnetic out-of-shaft angle measurement system with a tangential sensor arrangement.

The left-hand side of FIG. 6 initially shows the raw output signals (“By Signals”) from the two sensor devices 110A, 110B. Due to the tangential arrangement, the magnetic-field-sensitive elements 112A, 112B each sense the tangentially oriented magnetic field along the circumference of the rotating shaft 102. In this case, two magnetic-field-sensitive elements 112A, 112B are arranged within each sensor device 110A, 110B tangentially offset from one another while positioned at the same radial distance from the shaft axis 103. The signals from the two elements 112A, 112B within each sensor device 110A, 110B thus have similar amplitudes but have slight phase shifts on account of their positions on the circumference.

The middle part of FIG. 6 shows how a differential sine and cosine output signal is produced within each sensor device 110A, 110B by forming the difference between the two tangentially offset sensor elements 112A, 112B. These differential signals enable the precise calculation of the angular position of the shaft.

Finally, in the right-hand part of FIG. 6, the measured angle values are shown over a full rotation of 360°. Curve 610 indicates the measured angle values, while curve 620 shows the measurement errors that occur over the rotation of the shaft. The measurement error shown remains small but has occasional peaks which are attributable to the increased sensitivity to stray fields owing to the tangential arrangement. In the tangential arrangement, stray magnetic fields are partially amplified, especially in the case of a ferromagnetic shaft, and this can lead to a slightly reduced robustness in relation to interfering influences. The tangential arrangement is nevertheless distinguished by the possibility of a very compact construction, which is useful in particular in applications with restricted installation space. Using suitable signal processing, for example with the aid of a microcontroller or ASIC with subsequent signal correction, a high angle measurement accuracy can also be achieved in this arrangement.

In summary, a magnetic OoS angle measurement system is proposed, comprising a diametrically magnetized permanent magnet (in ring or disk form) and two differential sensors 110A, 110B which are arranged at an angular offset of 90° (electrical angle) with respect to one another. In this case, one sensor is located at the centre of a magnetic pole, while the other is positioned at the pole transition zone. As the shaft rotates, the two sensors provide differential output signals (sine and cosine signals) that have a high stray field robustness. The angular position of the shaft can be calculated from these signals with the aid of an ASIC or a microcontroller.

In a preferred implementation, the chip is oriented parallel to the shaft (YZ-plane), wherein the sensor elements 112A, 112B (xMR or VHALL sensors) respond to the axial magnetic field generated by the permanent magnet.

In a second implementation, the chip is aligned in the XY-plane such that the sensor elements are sensitive to the radial magnetic field component. In this case, the first and second sensor elements 112A, 112B are positioned at different radial distances from the magnet such that there is an air gap difference between them.

In a third implementation, the chip is also aligned in the XY-plane, but the sensor elements respond to the tangential magnetic field in this case. In this configuration, the sensor elements are at the same radial distance from the centre of the shaft or magnet.

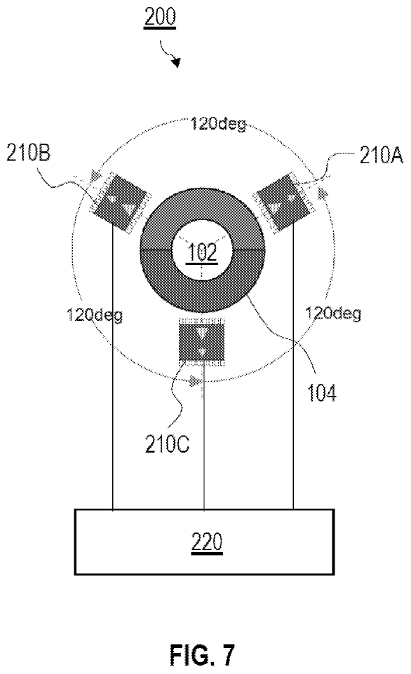

FIG. 7 shows a schematic illustration of an apparatus 200 according to a further example implementation for determining the angle of a rotating shaft 102. The apparatus 200 comprises at least three magnetic field sensors 210 (210A, 210B, 210C) which are arranged around a permanent magnet 104 fastened to the shaft 102, and an evaluation unit 220.

The permanent magnet 104 can be in the form of a diametrically magnetized ring or disk magnet, as has been described in connection with the preceding example implementations. In some example implementations, the permanent magnet 104 can be embodied as an inexpensive ferrite magnet without rare-earth elements.

In contrast to the example implementation with two magnetic field sensors described in connection with FIG. 1 to FIG. 6, the apparatus 200 according to FIG. 7 comprises three magnetic field sensors 210A, 210B, 210C. These three magnetic field sensors 210A, 210B, 210C can be arranged around the permanent magnet 104 with an equidistant angular spacing of 120° from one another in each case, as illustrated in FIG. 7. In this case, the magnetic field sensors 210 can be arranged radially outside the permanent magnet 104 such that the magnetic field generated by the permanent magnet 104 is sensed substantially in the radial direction by the magnetic field sensors 210. This symmetrical arrangement can contribute to at least partially compensating for magnetization-related errors and geometric imperfections of the permanent magnet 104, such as inhomogeneities in the magnet material, variations in the remanence flux density or manufacturing-related irregularities.

In some example implementations, an air gap between the permanent magnet 104 and the magnetic field sensors 210 can be greater than 3 mm. An enlarged air gap can contribute to reducing the influence of higher harmonics of the magnetic field, since these decay more strongly than the fundamental oscillation as the distance from the permanent magnet 104 increases. This may improve signal quality and reduce the angle calculation error. Moreover, a larger air gap can reduce the mechanical requirements on the mounting accuracy of the magnetic field sensors 210 and enable easier integration into the surrounding system.

Each of the three magnetic field sensors 210A, 210B, 210C is configured to sense a component of the magnetic field generated by the permanent magnet 104 and output a corresponding sensor signal. In some example implementations, each magnetic field sensor 210 may be configured to sense a radial component of the magnetic field. In alternative example implementations, it is also possible to sense an axial or tangential field component, as described in conjunction with the preceding figures.

In some example implementations, the magnetic field sensors 210 can be in the form of TMR sensors which, owing to their high sensitivity and their low noise, can be particularly suitable for high-resolution angle measurement applications. Alternatively, the magnetic field sensors 210 can be in the form of a different type of xMR sensor or in the form of a vertical Hall sensor.

In some example implementations, each magnetic field sensor 210 can be in the form of a differential sensor with two magnetic-field-sensitive measuring elements, wherein the respective magnetic field sensor 210 can be configured to form a difference signal from the measurement signals from its two measuring elements. The differential measuring arrangement makes it possible to achieve increased robustness vis-à-vis homogeneous interference fields, such as for instance external stray fields. The spatial arrangement of the two magnetic-field-sensitive measuring elements of each magnetic-field sensor 210 can be selected in such a way here that either an axial or a tangential field component is sensed differentially, as described in connection with the preceding figures.

The evaluation unit 220 is configured to receive the sensor signals from the three magnetic field sensors 210A, 210B, 210C and to derive a sine signal and a cosine signal therefrom using a transformation. In some example implementations, the transformation can be a Clarke transformation which is applied to the three sensor signals offset by 120° in each case in order to generate two orthogonal signal components. Based on the sine signal and cosine signal thus obtained, the evaluation unit 220 can calculate the angle information of the shaft 102, for example using the atan 2 function.

For illustrative purposes, the assumption is made that the three magnetic field sensors 210A, 210B, 210C output the following sensor signals for a given angular position φ of the shaft 102:

$${S}_{A} ( φ ) = A \cdot cos ( φ ) \\ {S}_{B} ( φ ) = A \cdot cos ( φ - \frac{2 π}{3} ) \\ {S}_{C} ( φ ) = A \cdot cos ( φ - \frac{4 π}{3} )$$

where A denotes the signal amplitude, and the three signals are each offset by 120° from one another. The Clarke transformation can then be applied to these three signals in order to generate two orthogonal signal components S_{α} and S_{β}:

$${S}_{α} = \frac{2}{3} ( {S}_{A} - \frac{1}{2} {S}_{B} - \frac{1}{2} {S}_{C} ) \\ {S}_{β} = \frac{2}{3} ( \frac{\sqrt{3}}{2} {S}_{B} - \frac{\sqrt{3}}{2} {S}_{C} )$$

Inserting the sensor signals results in:

S_{α}=A·cos(φ),S_{β}=A·sin(φ)

The signal components S_{α} and S^{β} thus obtained correspond to a cosine signal or a sine signal, which can be used directly for calculating the angle. From this, the evaluation unit 220 can calculate the angle information of the shaft 102 according to the following relationship:

φ=atan 2(S_{β},S_{α})

An advantage of this procedure can be that a common direct component (common mode offset), which is overlaid on all three sensor signals, is algebraically eliminated by the Clarke transformation. This can contribute to reducing measurement errors that can be caused by temperature drift, ageing or external interference fields without an explicit offset calibration being absolutely necessary.

Alternatively, the transformation may comprise a linear transformation based on the Moore-Penrose pseudo-inverse, a least squares estimate or a discrete Fourier transform. The choice of transformation can depend on the specific arrangement of the magnetic field sensors 210 and on the respective requirements in terms of computational complexity and robustness.

In some example implementations, the evaluation unit 220 can furthermore comprise signal processing, which can perform an offset and amplitude correction and optionally an ellipse fit to the input signals before the angle calculation takes place. These calibration steps can contribute to reducing remaining systematic errors in the sensor signals.

For illustrative purposes, the assumption is made that the evaluation unit 220, after application of the Clarke transformation, provides two signal components S_{α} and Sg which, in the ideal case, have the following form:

$${S}_{α}^{ideal} = A \cdot cos ( φ ) , {S}_{β}^{ideal} = A \cdot sin ( φ )$$

In practice, however, these signals may be afflicted by additive offset components O_{α}, O_{β}, by amplitudes A_{α}≠A_{β} which deviate from one another and by a phase offset error δ, and so the signals actually present may assume the following form:

$${S}_{α}^{real} = {A}_{α} \cdot cos ( φ ) + {O}_{α} \\ {S}_{β}^{real} = {A}_{β} \cdot sin ( φ + δ ) + {O}_{β}$$

The direct insertion of these error-afflicted signals into the atan 2 function may lead to a periodic angle error. Such errors can be caused, for example, by manufacturing tolerances of the magnetic field sensors 210, by mechanical assembly tolerances, by temperature drift or by inhomogeneities in the permanent magnet 104.

In a first step, the evaluation unit 220 can determine and subtract the offset components O_{α} and O_{β}. By way of example, the offset components can be estimated as temporal mean values of the signals

$${S}_{α}^{real} and {S}_{β}^{real}$$

over a complete revolution of the shaft 102:

$${\hat{O}}_{α} = \frac{1}{2 π} {\int }_{0}^{2 π} {S}_{α}^{real} ( φ ) d φ , {\hat{O}}_{β} = \frac{1}{2 π} {\int }_{0}^{2 π} {S}_{β}^{real} ( φ ) d φ$$

After the offset subtraction, the offset-corrected signals remain:

$${\tilde{S}}_{α} = {S}_{α}^{real} - {\hat{O}}_{α} = {A}_{α} \cdot cos ( φ ) \\ {\tilde{S}}_{β} = {S}_{β}^{real} - {\hat{O}}_{β} = {A}_{β} \cdot sin ( φ + δ )$$

In a second step, the evaluation unit 220 can carry out an amplitude correction in order to establish an amplitude equality of the two signal components. The amplitudes Ag and Ag can be estimated, for example, as maximum values of the respective offset-corrected signals over a complete revolution:

Â_{α}=max_{φ}|Š_{α}(φ)|,Â_{β}=max_{φ}|Š_{β}(φ)|

The amplitude-corrected signals can then be calculated by normalization to a common reference amplitude Aref.

$${\overline{S}}_{α} = \frac{{A}_{ref}}{{\hat{A}}_{α}} \cdot {\tilde{S}}_{α} , {\overline{S}}_{β} = \frac{{A}_{ref}}{{\hat{A}}_{β}} \cdot {\tilde{S}}_{β}$$

In some example implementations, the evaluation unit 220 can optionally perform an ellipse fit in order to correct remaining errors, in particular a phase offset error δ between the two signal components. The basic idea of the ellipse fit is that the Lissajous figure, which is produced by the plotting \tilde{S}_{β} over \tilde{S}_{α}, describes a circle in the error-free case. Amplitude differences and phase offset errors deform this circle into an ellipse, as shown in the following equations:

$$\frac{{\tilde{S}}_{α}^{2}}{{A}_{α}^{2}} + \frac{{\tilde{S}}_{β}^{2}}{{A}_{β}^{2}} - \frac{2 cos ( δ )}{{A}_{α} {A}_{β}} {\tilde{S}}_{α} {\tilde{S}}_{β} = {sin}^{2} ( δ )$$

The evaluation unit 220 can be configured to estimate the parameters of this ellipse—in particular the semi-axes and the orientation—from the signal pairs

$$( {S}_{α}^{real} , {S}_{β}^{real} )$$

acquired during operation, for example using a least squares method. From the estimated ellipse parameters, the evaluation unit 220 can subsequently calculate a linear transformation matrix M, which maps the ellipse onto a unit circle:

$$[ \begin{matrix}{S}_{α}^{co rr} & {S}_{β}^{corr}\end{matrix} ] = M [ \begin{matrix}{\overline{S}}_{α} & {\tilde{S}}_{β}\end{matrix} ]$$

The signals

$${S}_{α}^{corr} and {S}_{β}^{corr}$$

corrected in this way can then be supplied to the angle calculation according to

$$φ = atan 2 ( {S}_{β}^{corr} , {S}_{α}^{corr} ) .$$

In some example implementations, the calibration parameters can be determined once during a calibration phase, for example during the commissioning of the apparatus 200, and stored in a non-volatile memory of the evaluation unit 220. In other example implementations, the evaluation unit 220 can be configured to update the calibration parameters adaptively during ongoing operation in order to continuously compensate for slow changes in the sensor properties, for example as a result of ageing or temperature fluctuations.

The evaluation unit 220 can be in the form of an application-specific integrated circuit (ASIC), a microcontroller or a field-programmable gate array (FPGA) or can comprise a combination of these components, as described in connection with the preceding example implementations.

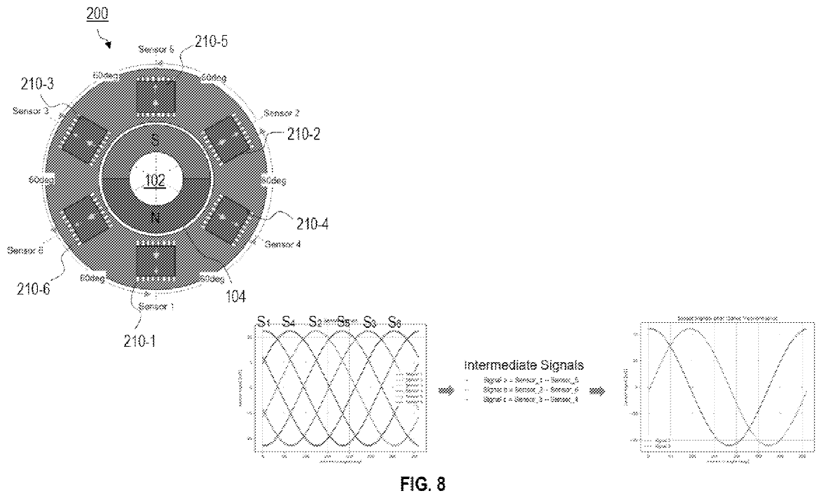

FIG. 8 shows a schematic illustration of a further implementation of the apparatus 200 for determining the angle of the rotating shaft 102. The example implementation illustrated in FIG. 8 differs from the example implementation described in FIG. 7 in that, instead of three magnetic field sensors, six magnetic field sensors 210 (210-1, 210-2, 210-3, 210-4, 210-5, 210-6) are provided. These can be arranged around the permanent magnet 104 with an equidistant angular spacing of 60° from one another in each case, as illustrated in FIG. 8.

With regard to the construction and function of the permanent magnet 104, the shaft 102 and the evaluation unit 220, the statements made in connection with FIG. 7 apply correspondingly.

The evaluation unit 220 (not explicitly illustrated in FIG. 8) can be configured to initially calculate three intermediate signals Dₐ, D_{b}, D_{c} from the six sensor signals. In this case, each intermediate signal can be formed from the difference between the sensor signals from two magnetic field sensors lying opposite one another:

D_{α}=S₁−S₅,D_{b}=S₂−S₆,D_{c}=S₃−S₄

where Sₖ denotes the sensor signal of the magnetic field sensor 210-k. In this case, the three opposing sensor pairs are (210-1, 210-5), (210-2, 210-6) and (210-3, 210-4), respectively, wherein each sensor and its respective opposing partner are arranged offset by 180°.

For illustrative purposes, the assumption is made that the six magnetic field sensors 210-1 to 210-6 output the following sensor signals at an angular position φ of the shaft 102, where denotes the respective angular position of the sensor 210-k at the circumference of the permanent magnet 104:

Sₖ(φ)=A·cos(φ−φₖ)

Since each sensor 210-k and its opposing partner are arranged offset by 180° in each case, the following applies to the corresponding signals:

Sₒₚₚₒₛᵢₜₑ(φ)=A·cos(φ−φₖ−180°)=−A·cos(φ−φₖ)=−Sₖ(φ)

Subtraction thus provides for each sensor pair:

Dₐ=S₁−S₅=2A·cos(φ−φ₁)

D_{b}=S₂−S₆=2A·cos(φ−φ₂)

D_{c}=S₃−S₄=2A·cos(φ−φ₃)

where the angular positions φ₁, φ₂, φ₃ of the three reference sensors 210-1, 210-2, 210-3 are each spaced apart by 120° from one another. The intermediate signals Dₐ, D_{b}, D_{c} thus formed therefore have the same mutual phase offset of 120° as the sensor signals in the three-sensor example implementation described in FIG. 7 but have twice the signal amplitude 2A. This increased signal amplitude can contribute to improving the signal-to-noise ratio and to increasing the angle determination accuracy.

The evaluation unit 220 can be configured to apply the Clarke transformation to the three intermediate signals Dₐ, D_{b}, D_{c} in order to derive a sine signal S and a cosine signal Sa therefrom. In this case, the calculation is carried out analogously to the example implementation described in FIG. 7, with the difference that the input signals of the transformation are the intermediate signals Dₐ, D_{b}, D_{c}:

$${S}_{α} = \frac{2}{3} ( {D}_{a} - \frac{1}{2} {D}_{b} - \frac{1}{2} {D}_{c} ) = 2 A \cdot cos ( φ ) \\ {S}_{β} = \frac{2}{3} ( \frac{\sqrt{3}}{2} {D}_{b} - \frac{\sqrt{3}}{2} {D}_{c} ) = 2 A \cdot sin ( φ )$$

Based on S_{α} and S_{β}, the evaluation unit 220 can calculate the angle information in accordance with φ=atan 2 (S_{β},S_{α}). The signal curves 240 shown at the bottom right in FIG. 8 show the resulting sine signal (shown as a solid line, Signal 1) and the cosine signal (shown as a dashed line, Signal 2) after the application of the Clarke transformation.

An advantage of the six-sensor arrangement shown in FIG. 8 compared to the three-sensor arrangement according to FIG. 7 can lie in the increased robustness vis-à-vis external interference fields and vis-à-vis assembly errors. Since the difference signals only detect the antisymmetric component of the magnetic field, homogeneous external stray fields, which act equally on all six sensors, can be effectively suppressed by the subtraction.

Furthermore, assembly tolerances, such as an off-centred arrangement of the printed circuit board (PCB offset), can be at least partially compensated for by the symmetrical arrangement of the mutually opposing sensor pairs.

This can contribute to reducing the adjustment outlay during assembly and to improving the robustness of the apparatus 200 with respect to manufacturing-related tolerances.

In some example implementations, the evaluation unit 220 can further be configured to check the plausibility of the three intermediate signals 230a, 230b, 230c with respect to one another in order to identify faulty sensor signals and provide appropriate diagnostic information.

While FIG. 7 describes an arrangement with exactly three magnetic field sensors 210 (k=1), and FIG. 8 describes an arrangement with six magnetic field sensors 210 (k=2), the apparatus 200 according to the present example implementation can comprise a number N=3 k of magnetic field sensors 210, where k≥2 is an integer.

In this case, the N magnetic field sensors 210 can be arranged with a uniform angular spacing of 360°/N around the shaft 102, with the result that a completely equidistant sensor arrangement is present. With regard to the construction and properties of the individual magnetic field sensors 210 and of the permanent magnet 104, the statements made in connection with the preceding figures apply correspondingly.

The evaluation unit 220 can be configured to divide the N magnetic field sensors 210 into k subsets T₁, T₂, . . . , Tₖ of three magnetic field sensors 210 each. The three magnetic field sensors 210 of each subset Tᵢ can be selected such that they are each arranged offset by 120° with respect to one another on the circumference of the permanent magnet 104.

By way of illustration, consideration is given to the example N=6 (k=2), as illustrated in FIG. 8. The six magnetic field sensors 210-1 to 210-6 with an angular spacing of 60° in each case can be divided into two subsets:

T₁={210-1,210-2,210-3}

T₂={210-4,210-5,210-6}

In this case, the three sensors of each subset each have an angular offset of 120° with respect to one another and thus in turn form a complete three-sensor arrangement according to FIG. 7.

For a further example implementation with N=9 (k=3) and an angular spacing of 40° between adjacent sensors, three subsets can be formed. Here, too, the three sensors of each subset in each case have an angular offset of 120° with respect to one another.

For each subset Tᵢ, the evaluation unit 220 can be configured to perform a Clarke transformation on the three associated sensor signals S_{i,1}, S_{i,2}, S_{i,3}, as described in connection with FIG. 7. A cosine signal S_{α,i} and a sine signal can S_{β,i} be derived for each subset Tᵢ from the Clarke transformation. The evaluation unit 220 can then calculate a partial angle oi for each subset Tᵢ:

φᵢ=atan 2(S_{β,i},S_{α,i}),i=1, . . . ,k

The evaluation unit 220 can be configured to calculate the final rotation angle @ of the shaft 102 as the mean value of the k partial angles:

$$\hat{φ} = \frac{1}{k} {\sum }_{i = 1}^{k} {φ}_{i}$$

In some example implementations, the averaging can be performed as a weighted average, wherein different weights can be assigned to individual subsets in order, for example, to give less weight to sensors with known higher noise or greater deviation.

A stepwise improvement of the angle determination accuracy can be achieved by increasing the number k of subsets and hence the total number of magnetic field sensors 210. Each additional subset supplies an independent estimated value for the rotation angle of the shaft 102, and so random measurement deviations can be statistically reduced as a result of the averaging. In addition, systematic errors resulting from inhomogeneities of the magnetic field or from manufacturing tolerances of individual magnetic field sensors 210 can be at least partially compensated for by the spatial oversampling of the magnetic field.

In some example implementations, the evaluation unit 220 can furthermore be configured to check the k partial angles φ₁, . . . , φₖ with respect to one another for plausibility. If a partial angle φᵢ deviates from the other partial angles by more than a predefinable threshold value, the evaluation unit 220 can disregard this partial angle in the averaging and optionally output a corresponding diagnostic signal. In this way, the apparatus 200 can continue to provide a reliable angle value even in the event of a failure or a malfunction of individual magnetic field sensors 210.

Although specific implementations and example implementations have been described in the present disclosure, it will be understood by a person skilled in the art that the present disclosure is not limited thereto. Rather, the described implementations can be modified and combined with one another in a variety of ways without departing from the scope of protection of the present disclosure.

In particular, individual features of the described example implementations-such as the number and arrangement of the magnetic field sensors, the type of magnetic-field-sensitive elements, the geometry and magnetization direction of the permanent magnet, the transformation used for signal processing and the configuration of the evaluation unit—can be selected independently of one another and combined with one another in any technically meaningful manner. Thus, for example, a differential axial sensor arrangement according to FIG. 1 can be combined with a six-sensor configuration according to FIG. 8, or a Clarke transformation according to FIG. 7 can be combined with an ellipse fit for calibration according to the corresponding example implementations, provided that this is technically feasible and not contradictory.

Terms such as “comprises”, “has”, “contains” or “includes” and their grammatical variations, as used in the present disclosure, should not be understood as exhaustive and do not preclude the presence of further elements, features, steps or components. Furthermore, singular formulations should not be understood as a limitation to exactly one element unless expressly stated otherwise.

Insofar as numerical values, angular ranges, distances or other quantitative data are mentioned in the present disclosure, these should be understood as non-exhaustive examples. A person skilled in the art will recognize that deviating values can also be chosen depending on the respective requirements for the application.

The example implementations described in the present disclosure can be used to solve angle measurement tasks in a multiplicity of technical fields of application, in particular in automotive electronics, industrial automation, robotics and in medical engineering systems, without the present disclosure being restricted to these fields.

It is understood that the present disclosure encompasses all technically feasible combinations and modifications of the described features, even if not explicitly described. The scope of protection of the present disclosure is defined by the appended claims.

It should be pointed out that the description and the drawings only illustrate the principles of the proposed methods and apparatuses. A person skilled in the art will be capable of implementing different arrangements which, although not expressly described or shown here, embody the principles of the implementation and are contained within the scope thereof. In addition, all examples and implementations outlined in the present document are intended fundamentally and expressly for explanatory purposes only, in order to help the reader understand the principles of the proposed methods and apparatuses. In addition, all statements in this document that describe principles, aspects and implementations of the implementation and specific examples thereof are also intended to encompass their equivalents.

### ASPECTS

The following provides an overview of some Aspects of the present disclosure:
Aspect 1: An apparatus for determining an angle of a rotating shaft, comprising: a permanent magnet which has at least one magnetic pole pair and is fastened to the rotating shaft; at least two magnetic sensor devices which are spaced apart from one another, which are each arranged around the rotating shaft at a pole-pair-dependent angular offset from one another and which each comprise at least two magnetic-field-sensitive elements that generate differential output signals; and an evaluation unit which is configured to receive the differential output signals provided by the at least two sensor devices and determine angle information of the rotating shaft therefrom.
Aspect 2: The apparatus according to Aspect 1, wherein the permanent magnet is formed as a two-pole magnet, and the at least two magnetic sensor devices are arranged around the rotating shaft at an angular offset of 90° from one another.
Aspect 3: The apparatus according to any of Aspects 1-2, wherein the permanent magnet is in the form of a ring or a disk.
Aspect 4: The apparatus according to any of Aspects 1-3, wherein each of the magnetic sensor devices comprises two magnetic field sensors in the form of xMR or VHall sensor elements.
Aspect 5: The apparatus according to any of Aspects 1-4, wherein the at least two magnetic sensor devices each have the same radial distance from the permanent magnet.
Aspect 6: The apparatus according to any of Aspects 1-5, wherein the at least two magnetic-field-sensitive elements of the magnetic sensor devices are each arranged in one plane which extends either parallel or perpendicular to a shaft axis of the rotating shaft.
Aspect 7: The apparatus according to any of Aspects 1-6, wherein the at least two magnetic-field-sensitive elements of the magnetic sensor devices are each arranged axially spaced in one plane which extends parallel to a shaft axis of the rotating shaft.
Aspect 8: The apparatus according to any of Aspects 1-7, wherein the at least two magnetic-field-sensitive elements of the magnetic sensor devices are each arranged radially spaced in one plane which extends perpendicular to a shaft axis of the rotating shaft.
Aspect 9: The apparatus according to any of Aspects 1-8, wherein the magnetic-field-sensitive elements of the magnetic sensor devices are each arranged tangentially spaced in one plane which extends perpendicular to a shaft axis of the rotating shaft.
Aspect 10: The apparatus according to any of Aspects 1-9, wherein the rotating shaft is not ferromagnetic.
Aspect 11: A method for determining an angle of a rotating shaft, comprising: fastening a permanent magnet which has at least one magnetic pole pair to the rotating shaft; arranging at least two magnetic sensor devices which are arranged around the rotating shaft at a pole-pair-dependent angular offset from one another and which each comprise at least two magnetic-field-sensitive elements; acquiring differential output signals by the at least two magnetic sensor devices; and evaluating the differential output signals to determine the angle.
Aspect 12: An apparatus for determining an angle of a rotating shaft, comprising: a permanent magnet which has at least one magnetic pole pair and is fastened to the rotating shaft; at least three magnetic field sensors arranged around the permanent magnet with equidistant angular spacing, wherein each magnetic field sensor is configured to sense a magnetic field generated by the permanent magnet and output a corresponding sensor signal; and an evaluation unit, which is configured to: receive the sensor signals from the at least three magnetic field sensors, derive a sine signal and a cosine signal from the sensor signals using a transformation, and calculate angle information of the rotating shaft based on the sine signal and the cosine signal.
Aspect 13: The apparatus according to Aspect 12, wherein each magnetic field sensor is configured to sense a radial component of the magnetic field generated by the permanent magnet.
Aspect 14: The apparatus according to any of Aspects 12-13, wherein the permanent magnet is diametrically magnetized.
Aspect 15: The apparatus according to any of Aspects 12-14, wherein the transformation is a Clarke transformation.
Aspect 16: The apparatus according to any of Aspects 12-15, wherein the magnetic field sensors are in the form of TMR sensors.
Aspect 17: The apparatus according to any of Aspects 12-16, wherein each magnetic field sensor is in the form of a differential sensor with two magnetic-field-sensitive measuring elements, wherein each magnetic field sensor is configured to form a difference signal from the measurement signals from its two measuring elements.
Aspect 18: The apparatus according to Aspect 17, wherein the two magnetic-field-sensitive measuring elements of each magnetic field sensor are arranged such that either: an axial component of the magnetic field generated by the permanent magnet is sensed differentially, wherein a chip plane of each magnetic field sensor is aligned substantially parallel to a surface of the rotating shaft or of the permanent magnet; or a tangential component of the magnetic field generated by the permanent magnet is sensed differentially, wherein the magnetic-field-sensitive measuring elements are spaced apart from one another along a tangent on a circumference of the rotating shaft and are arranged at the same radial distance from an axis of the rotating shaft.
Aspect 19: The apparatus according to any of Aspects 12-18, wherein exactly three magnetic field sensors are provided and arranged with an angular spacing of 120° from one another around the permanent magnet.
Aspect 20: The apparatus according to any of Aspects 12-19, wherein exactly six magnetic field sensors are provided and arranged with an angular spacing of 60° from one another around the permanent magnet.
Aspect 21: The apparatus according to Aspect 20, wherein the evaluation unit is furthermore configured to: calculate three intermediate signals, wherein each intermediate signal is formed from a difference between the sensor signals from two opposing magnetic field sensors; and apply the transformation to the three intermediate signals.
Aspect 22: The apparatus according to any of Aspects 12-21, wherein the permanent magnet is a ferrite magnet.
Aspect 23: The apparatus according to any of Aspects 12-22, wherein the permanent magnet is in the form of a ring or a disk.
Aspect 24: The apparatus according to any of Aspects 12-23, wherein the magnetic field sensors are arranged radially outside the permanent magnet.
Aspect 25: The apparatus according to any of Aspects 12-24, wherein an air gap between the permanent magnet and the magnetic field sensors is greater than 3 mm.
Aspect 26: The apparatus according to any of Aspects 12-25, wherein the evaluation unit is furthermore configured to carry out a calibration, comprising: normalizing the sensor signals by way of offset correction and amplitude correction; and/or fitting an ellipse to extract correction factors.
Aspect 27: The apparatus according to any of Aspects 12-26, wherein the evaluation unit is configured to calculate the angle information from the sine signal and the cosine signal using an atan 2 function.
Aspect 28: The apparatus according to any of Aspects 12-27, wherein the rotating shaft is not ferromagnetic.
Aspect 29: The apparatus according to any of Aspects 12-28, wherein: the apparatus comprises a number N=3 k (k≥2) of magnetic field sensors arranged around the rotating shaft with a uniform angular spacing of 360°/N; the evaluation unit is configured to divide the N magnetic field sensors into k subsets of three magnetic field sensors each, wherein the three magnetic field sensors of each subset are offset from one another by 120° in each case; the evaluation unit performs a Clarke transformation on three associated sensor signals for each subset in order to obtain one sine signal and one cosine signal in each case; the evaluation unit determines a partial angle from each sine/cosine pair using an arctangent function; and the evaluation unit calculates a final rotation angle of the rotating shaft as a mean value of the k partial angles.
Aspect 30: A method for determining an angle of a rotating shaft, comprising: sensing a radial magnetic field component using at least three magnetic field sensors which are arranged with equidistant angular spacing around a diametrically magnetized permanent magnet that is fastened to the rotating shaft, wherein each magnetic field sensor outputs a corresponding sensor signal; deriving a sine signal and a cosine signal from the sensor signals from the at least three magnetic field sensors using a transformation; and calculating angle information of the rotating shaft based on the sine signal and the cosine signal.
Aspect 31: An angle measurement system for 360° absolute angle detection, comprising: a rotatable shaft; a diametrically magnetized permanent magnet rotationally conjointly connected to the rotating shaft; a printed circuit board arranged stationarily relative to the rotating shaft; at least three magnetic field sensors mounted on the printed circuit board with equidistant angular spacing around the permanent magnet, wherein each magnetic field sensor is configured to sense a radial magnetic field component; and a processor configured to: receive the sensor signals from the at least three magnetic field sensors, derive a sine signal and a cosine signal using a transformation, and calculate an absolute angle value of the rotating shaft.
Aspect 32: A computer program product comprising instructions which, when executed by a processor, cause the processor to: receive sensor signals from at least three magnetic field sensors arranged with equidistant angular spacing around a diametrically magnetized permanent magnet; derive a sine signal and a cosine signal from the sensor signals using a transformation; and calculate angle information based on the sine signal and the cosine signal.
Aspect 33: A system configured to perform one or more operations recited in one or more of Aspects 1-32.
Aspect 34: An apparatus comprising means for performing one or more operations recited in one or more of Aspects 1-32.
Aspect 35: A non-transitory computer-readable medium storing a set of instructions, the set of instructions comprising one or more instructions that, when executed by a device, cause the device to perform one or more operations recited in one or more of Aspects 1-32.
Aspect 36: A computer program product comprising instructions or code for executing one or more operations recited in one or more of Aspects 1-32.

1. An apparatus for determining an angle of a rotating shaft, comprising:
a permanent magnet which has at least one magnetic pole pair and is fastened to the rotating shaft;
at least two magnetic sensor devices which are spaced apart from one another, which are each arranged around the rotating shaft at a pole-pair-dependent angular offset from one another and which each comprise at least two magnetic-field-sensitive elements that generate differential output signals; and
an evaluation unit which is configured to receive the differential output signals provided by the at least two sensor devices and determine angle information of the rotating shaft therefrom.

2. The apparatus according to claim 1, wherein the permanent magnet is formed as a two-pole magnet, and the at least two magnetic sensor devices are arranged around the rotating shaft at an angular offset of 90° from one another.

3. The apparatus according to claim 1, wherein the permanent magnet is in the form of a ring or a disk.

4. The apparatus according to claim 1, wherein each of the magnetic sensor devices comprises two magnetic field sensors in the form of xMR or VHall sensor elements.

5. The apparatus according to claim 1, wherein the at least two magnetic sensor devices each have the same radial distance from the permanent magnet.

6. The apparatus according to claim 1, wherein the at least two magnetic-field-sensitive elements of the magnetic sensor devices are each arranged in one plane which extends either parallel or perpendicular to a shaft axis of the rotating shaft.

7. The apparatus according to claim 1, wherein the at least two magnetic-field-sensitive elements of the magnetic sensor devices are each arranged axially spaced in one plane which extends parallel to a shaft axis of the rotating shaft.

8. The apparatus according to claim 1, wherein the at least two magnetic-field-sensitive elements of the magnetic sensor devices are each arranged radially spaced in one plane which extends perpendicular to a shaft axis of the rotating shaft.

9. The apparatus according to claim 1, wherein the magnetic-field-sensitive elements of the magnetic sensor devices are each arranged tangentially spaced in one plane which extends perpendicular to a shaft axis of the rotating shaft.

10. The apparatus according to claim 1, wherein the rotating shaft is not ferromagnetic.

11. A method for determining an angle of a rotating shaft, comprising:
fastening a permanent magnet which has at least one magnetic pole pair to the rotating shaft;
arranging at least two magnetic sensor devices which are arranged around the rotating shaft at a pole-pair-dependent angular offset from one another and which each comprise at least two magnetic-field-sensitive elements;
acquiring differential output signals by the at least two magnetic sensor devices; and
evaluating the differential output signals to determine the angle.

12. An apparatus for determining an angle of a rotating shaft, comprising:
a permanent magnet which has at least one magnetic pole pair and is fastened to the rotating shaft;
at least three magnetic field sensors arranged around the permanent magnet with equidistant angular spacing, wherein each magnetic field sensor is configured to sense a magnetic field generated by the permanent magnet and output a corresponding sensor signal; and
an evaluation unit, which is configured to:
receive the sensor signals from the at least three magnetic field sensors, derive a sine signal and a cosine signal from the sensor signals using a transformation, and
calculate angle information of the rotating shaft based on the sine signal and the cosine signal.

13. The apparatus according to claim 12, wherein each magnetic field sensor is configured to sense a radial component of the magnetic field generated by the permanent magnet.

14. The apparatus according to claim 12, wherein the permanent magnet is diametrically magnetized.

15. The apparatus according to claim 12, wherein the transformation is a Clarke transformation.

16. The apparatus according to claim 12, wherein the magnetic field sensors are in the form of TMR sensors.

17. The apparatus according to claim 12, wherein each magnetic field sensor is in the form of a differential sensor with two magnetic-field-sensitive measuring elements, wherein each magnetic field sensor is configured to form a difference signal from the measurement signals from its two measuring elements.

18. The apparatus according to claim 17, wherein the two magnetic-field-sensitive measuring elements of each magnetic field sensor are arranged such that either:
an axial component of the magnetic field generated by the permanent magnet is sensed differentially, wherein a chip plane of each magnetic field sensor is aligned substantially parallel to a surface of the rotating shaft or of the permanent magnet; or
a tangential component of the magnetic field generated by the permanent magnet is sensed differentially, wherein the magnetic-field-sensitive measuring elements are spaced apart from one another along a tangent on a circumference of the rotating shaft and are arranged at the same radial distance from an axis of the rotating shaft.

19. The apparatus according to claim 12, wherein exactly three magnetic field sensors are provided and arranged with an angular spacing of 120° from one another around the permanent magnet.

20. The apparatus according to claim 12, wherein exactly six magnetic field sensors are provided and arranged with an angular spacing of 60° from one another around the permanent magnet.

21. The apparatus according to claim 20, wherein the evaluation unit is furthermore configured to:
calculate three intermediate signals, wherein each intermediate signal is formed from a difference between the sensor signals from two opposing magnetic field sensors; and
apply the transformation to the three intermediate signals.

22. The apparatus according to claim 12, wherein the permanent magnet is a ferrite magnet.

23. The apparatus according to claim 12, wherein the permanent magnet is in the form of a ring or a disk.

24. The apparatus according to claim 12, wherein the magnetic field sensors are arranged radially outside the permanent magnet.

25. The apparatus according to claim 12, wherein an air gap between the permanent magnet and the magnetic field sensors is greater than 3 mm.

26. The apparatus according to claim 12, wherein the evaluation unit is furthermore configured to carry out a calibration, comprising:
normalizing the sensor signals by way of offset correction and amplitude correction; and/or
fitting an ellipse to extract correction factors.

27. The apparatus according to claim 12, wherein the evaluation unit is configured to calculate the angle information from the sine signal and the cosine signal using an atan 2 function.

28. The apparatus according to claim 12, wherein the rotating shaft is not ferromagnetic.

29. The apparatus according to claim 12, wherein:
the apparatus comprises a number N=3 k (k≥2) of magnetic field sensors arranged around the rotating shaft with a uniform angular spacing of 360°/N;
the evaluation unit is configured to divide the N magnetic field sensors into k subsets of three magnetic field sensors each, wherein the three magnetic field sensors of each subset are offset from one another by 120° in each case;
the evaluation unit performs a Clarke transformation on three associated sensor signals for each subset in order to obtain one sine signal and one cosine signal in each case;
the evaluation unit determines a partial angle from each sine/cosine pair using an arctangent function; and
the evaluation unit calculates a final rotation angle of the rotating shaft as a mean value of the k partial angles.

30. A method for determining an angle of a rotating shaft, comprising:
sensing a radial magnetic field component using at least three magnetic field sensors which are arranged with equidistant angular spacing around a diametrically magnetized permanent magnet that is fastened to the rotating shaft, wherein each magnetic field sensor outputs a corresponding sensor signal;
deriving a sine signal and a cosine signal from the sensor signals from the at least three magnetic field sensors using a transformation; and
calculating angle information of the rotating shaft based on the sine signal and the cosine signal.

31. An angle measurement system for 360° absolute angle detection, comprising:
a rotatable shaft;
a diametrically magnetized permanent magnet rotationally conjointly connected to the rotating shaft;
a printed circuit board arranged stationarily relative to the rotating shaft;
at least three magnetic field sensors mounted on the printed circuit board with equidistant angular spacing around the permanent magnet, wherein each magnetic field sensor is configured to sense a radial magnetic field component; and
a processor configured to:
receive the sensor signals from the at least three magnetic field sensors,
derive a sine signal and a cosine signal using a transformation, and
calculate an absolute angle value of the rotating shaft.

32. A computer program product comprising instructions which, when executed by a processor, cause the processor to:
receive sensor signals from at least three magnetic field sensors arranged with equidistant angular spacing around a diametrically magnetized permanent magnet;
derive a sine signal and a cosine signal from the sensor signals using a transformation; and
calculate angle information based on the sine signal and the cosine signal.
